(19) United States
(12) Patent Application Publication
(10) Pub. No.: US 2007/0170104 A1
(43) Pub. Date: Jul. 26, 2007

(54) Filtration systems and filtration tanks for use therein

(76) Inventors: James-Wallace Belford, Mobile Post Hefer (IL); Erez Zimhoni, Kfar Hos (IL)

Correspondence Address: NATH & ASSOCIATES, 112 South West Street, Alexandria, VA, 22314, US

(21) Appl. No.: 11/337,005

(22) Filed: Jan. 23, 2006

(51) Int. Cl. B01D 36/04

(52) U.S. Cl. 210/295; 210/323.2; 210/512.1; 210/304

(57) ABSTRACT

A filtration tank with a central vertical axis comprises: a first chamber, a second chamber and at least one filter element. The first chamber has a first inlet through which fluid to be filtered enters the tank and is designed so as to provide a swirling flow of the fluid to the second chamber. The second chamber has a second inlet, in fluid communication with the first chamber, and an outlet through which filtered fluid exits the tank, the outlet being preferably disposed lower than the second inlet. The filter element may be disposed in the second chamber and may have a portion capable of free undulation due to movement of the fluid in which it is disposed caused at least in part by the swirling of fluid entering the second chamber. The swirling may be obtained by centrifugal forces induced within the tank at least in a portion of a fluid flow path preceding the second inlet. The tank may be used in a filtration system including a fixed head pressure column and a pipe system for providing fluid to the tank and the column. The fixed head pressure column has a top portion open to the atmosphere, and is mounted on and in fluid communication with the pipe system, for eliminating the suction of dirt into the pipe system.

### FIELD OF THE INVENTION

This invention relates to filtration systems and filtration tanks, in particular to filtration systems and filtration tanks with special filtration means and/or pressure regulation means adapted for use in irrigation.

### BACKGROUND OF THE INVENTION

Filtration tanks of the kind to which the present invention refers may have two chambers with a filter element therebetween such that the fluid is filtered when passing from one of the chambers to the other one, the first chamber being in fluid communication with an external source and the second chamber being in fluid communication with a pipe via which filtered fluid is to be forwarded to its place of use. Thus, the first chamber has a first inlet through which fluid to be filtered enters the tank, the second chamber has a second inlet in fluid communication with the first chamber, and an outlet through which filtered fluid exits the tank, and the filter element is disposed in the second inlet.

In filtration tanks of the kind described above, there may be various design of mutual disposition of the first and second inlets and the outlet. For example, in one known tank, the outlet is disposed lower than the second inlet.

### SUMMARY OF THE INVENTION

In accordance with a first aspect of the present invention, there is provided a filtration tank with a central vertical axis, comprising: a first chamber, a second chamber and at least one filter element; the first chamber having a first inlet through which fluid to be filtered enters the tank and being designed so as to provide a swirling flow of said fluid to the second chamber; the second chamber having a second inlet in fluid communication with the first chamber, and an outlet through which filtered fluid exits the tank, the outlet being disposed lower than the second inlet; the filter element being disposed in the second chamber and having a portion capable of free undulation due to movement of the fluid in which it is disposed caused at least in part by said swirling.

One of suggested applications of the filtration tank as defined above is for use in a drip irrigation system. In this case the filtration tank's outlet is adapted for being connected, via a dripper line manifold, to a drip irrigation system which may include drip emitters. Such drip emitters normally have a minimal pressure at which they are operable. To ensure that the drip irrigation system will receive fluid from the filtration tank at a pressure not lower than that minimal pressure, a hydraulic height between the second inlet and the irrigation dripper line manifold's inlet may be established accordingly. For the purposes of at least this aspect of the present invention at least part of the hydraulic height is established by positioning the second inlet a selected height above the filtration tank's outlet.

Further pressure regulation may be accomplished by disposing part of the second chamber in the filtration tank above part of the first chamber such that the second inlet of the second chamber is disposed higher than the first inlet of the first chamber. In this case a designated minimum pressure is required for the fluid from the first inlet to reach the height of the second inlet and access the second chamber. If the designated minimum pressure is not provided then fluid does not access the second chamber and hence the outlet, thereby providing a form of control for minimum pressure across the filtration tank.

The first chamber may further comprise an impurity accumulation chamber whose lowermost end is disposed lower than the first inlet, for accumulation of impurities that have been precipitated from the fluid.

The second inlet through which fluid enters the second chamber may be in the form of at least one aperture and the filter element may be in the form of an elongated filtering pocket adapted to receive fluid entering said aperture. The filter pocket may have an axial length approaching the vertical distance between the second inlet and the bottom of the second chamber.

The filtering pocket may have an open upper end fixed to receive fluid entering the second chamber through said aperture and a body with a closed end, extending into the second chamber and capable of free movement relative to the open end. In this case at least a portion of the pocket spaced from the open end is capable of freely undulating by forces exerted by the fluid flow.

Alternatively, the filter element may be in the form of an elongated sleeve having an open top end and an open lower end, the former being fixed to receive fluid from said aperture and the latter being in fluid communication with a disposal outlet of the tank. At least part of the body of the sleeve spaced from the fixed open end thereof, is capable of freely undulating by forces exerted by the fluid flow.

It should be noted that the filtration tank may have a plurality of filter elements which may be of any appropriate shape.

The filtration tank may further comprise a collection chamber in fluid communication with the filter element(s), the chamber including said disposal outlet through which impurities can exit the filtration tank. The collection chamber may further comprise a disposal pipe in fluid communication with the filter element(s).

The filter element may be made of any suitable material allowing its undulation as described above. In particular, it may be made from an inert polymer yarn. The non-rigid nature of the yarn may allow free undulation of the pocket caused by changes in the direction of the fluid flow. To further facilitate free undulation, the elongated pocket should be free of any restrictive enclosure. Furthermore, algaecide chemicals can be incorporated into the polymer yarn to further increase the time to blockage of the pocket.

Due to the shape and free undulation capabilities of the filter elements described above, the filtration tank according to the first aspect of the invention may have, inter alia, the following advantages:
localization of the filtered impurities for efficient collection and cleaning of the accumulated refuse;
increased filtration area;
self cleaning effect as a result of the free undulations, gravity and the downward fluid entry through the second inlet causing the refuse to be removed from the tubular portion of the pocket and deposited in the closed lower end thereof.

According to a second aspect of the present invention, there is provided a filtration tank with a central vertical axis, comprising: a first chamber, a second chamber and at least one filter element; the first chamber having a first inlet through which fluid to be filtered enters the tank; the second chamber having a second inlet in fluid communication with the first chamber, and an outlet through which filtered fluid exits the tank; the first inlet and/or the first chamber being designed so as to ensure that centrifugal forces are induced on fluid, with respect to the central vertical axis, upon and/or after the fluid's entrance into the first chamber, the filter element being disposed at least partially within the second chamber.

The first inlet and/or the shape of the first chamber may be designed so as to orient the flow path of fluid, at its the entrance into the first chamber, substantially tangentially to the periphery of the first chamber. This may be achieved, for example, by tangential orientation of the first inlet, which may be particularly efficient in combination with a substantially cylindrical shape of the first chamber. Such a design may increase turbulence in the first chamber by inducing centrifugal forces with respect to the central axis causing impurities to precipitate and sink to the floor of the first chamber. In a filtration tank where the first inlet is at a different height to the second inlet the resultant flow path may be substantially helical.

The first chamber may further comprise an impurity accumulation chamber whose lowermost end is disposed lower than the first inlet, for accumulation of the precipitated impurities mentioned above.

The filtration tank according to the second aspect of the invention may comprise filter elements capable of free undulation, similar to the filter elements in the filtration tank according to the first aspect of the invention. In cases where there is a substantially helical fluid flow path in the first chamber, additional turbulence in the second chamber may be caused by the helical flow path further increasing the free undulation of such filter elements and thereby increasing precipitation and filtering effectiveness.

A filtration tank of any of the above two aspects of the present invention may further comprise a turbulence generating device disposed, for example, in the path of the fluid flow between the first inlet and the uppermost end of the filter element. Such a turbulence generating device may be in the form of a static vane or vanes of any appropriate shape.

In accordance with a third aspect of the invention there is provided a filtration system comprising a filtration tank that may have any combination of the features described above and a control mechanism capable of varying the rate of fluid flow into said first inlet such that a regulated pressure range can be maintained for fluid flow across the filtration tank.

The control mechanism may have an inlet pipe in fluid connection with the first inlet, a valve mounted on the inlet pipe, and a pressure control sensor capable of detecting fluid pressure changes in the tank and activating the valve. The activation of the valve may cause a restriction in the fluid flow into the first inlet thereby:
allowing the use of flexible filter elements in the filtration tank that would normally not be able to be used due to their inability to withstand such high pressure conditions intact; or
allowing the use of such filter elements, which may withstand high pressure conditions, without fear of impurities being extruded through the filter elements.

In one embodiment the control mechanism further comprises a fixed head pressure column having a top portion open to the atmosphere, mounted on, and in fluid communication with, the inlet pipe disposed between the valve and the first inlet. The pressure control sensor may be in the form of a float sensor disposed in the column and adapted to sense fluid height changes in the column. There may be at least a first exhaust pipe having one end inserted in the top portion of the column and a second end in fluid communication with the first chamber or second chamber.

The fluid height in the column may rise due to an inflow of fluid from the at least first exhaust pipe, caused by excess fluid pressure in one or both of the chambers. It should be appreciated that the insertion of the at least first exhaust pipe into the top portion of the column which is open to the atmosphere essentially prevents the filter element from being subjected to pressure higher than the height of the fluid column. A further function of the column may be seen in circumstances where there occurs an unintentional stoppage of fluid flow into the pipe system preceding the column which causes fluid in the system to be sucked back in a reverse flow direction. The reverse flow may draw dirt into the pipe system via, for example, emitters used in an associated drip irrigation system thereby polluting the fluid in the pipe system. This pollution may be especially hazardous if part of the pipe system is used for purposes other than agriculture, for example providing drinking water. In such a case the column provides air to the pipe system via the open top portion consequently eliminating the suction of dirt into the pipe system.

In another embodiment the tank is disposed at an elevated position relative to the ground, for example, by mounting said tank onto a platform, and said pressure control sensor is disposed in the first chamber to detect excess fluid pressure in the tank.

The control mechanism may also comprise an irrigation meter for detecting and/or displaying fluid pressure changes in either the inlet pipe or an outlet pipe in fluid communication with the outlet.

According to further aspects of the invention, there are provided filtration systems for use with filtration tanks according to the first and second aspects of the invention.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a schematic plan view of a filtration tank in accordance with a first embodiment of one aspect of the present invention;

FIG. 2A is a schematic internal side view of the filtration tank shown in FIG. 1;

FIG. 2B is a schematic internal side view of a filtration tank in accordance with a second embodiment of the above aspect of the present invention;

FIG. 2C is a schematic internal side view of a filtration tank in accordance with a third embodiment of the above aspect of the invention;

FIG. 3 is a schematic view of a filtration system according to one embodiment of a second aspect of the invention;

FIG. 4 is a schematic view of a filtration system according to a second embodiment of the second aspect of the invention.

### DETAILED DESCRIPTION OF EXEMPLARY EMBODIMENTS

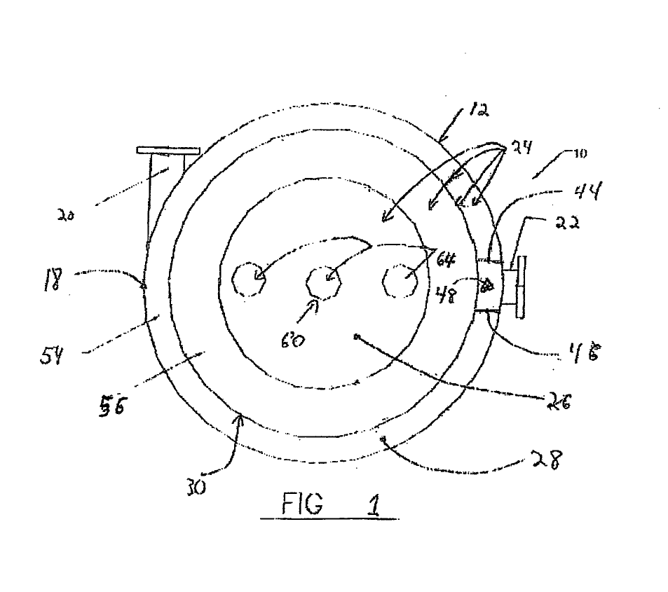

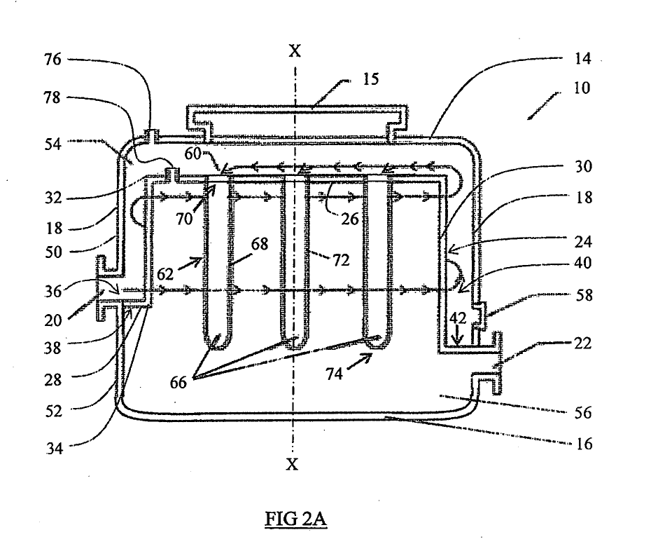

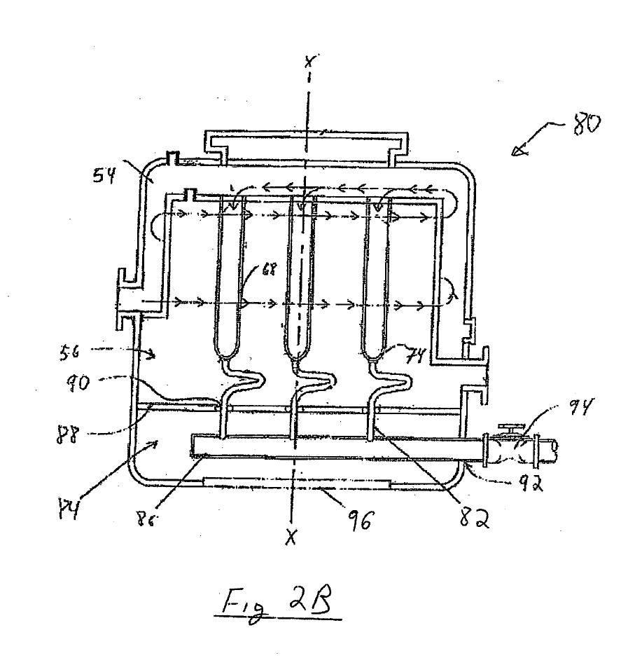

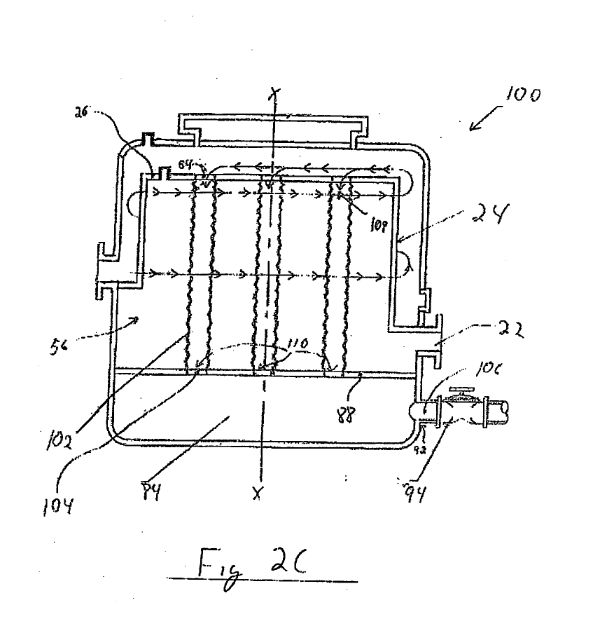

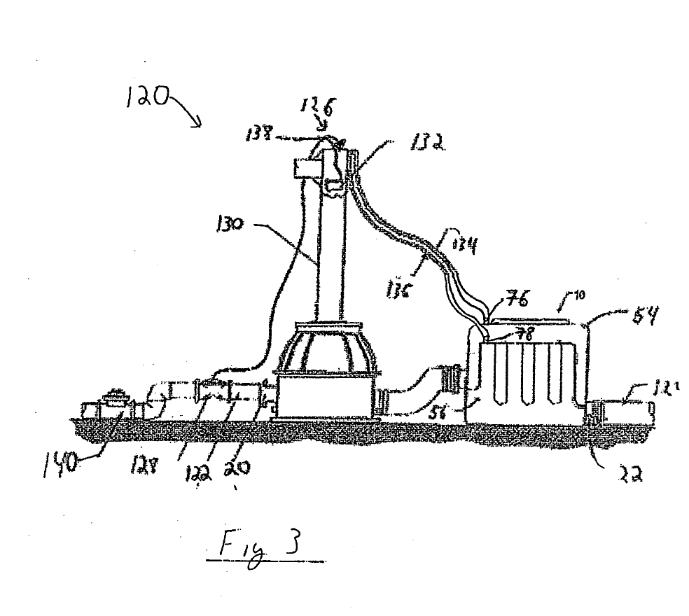

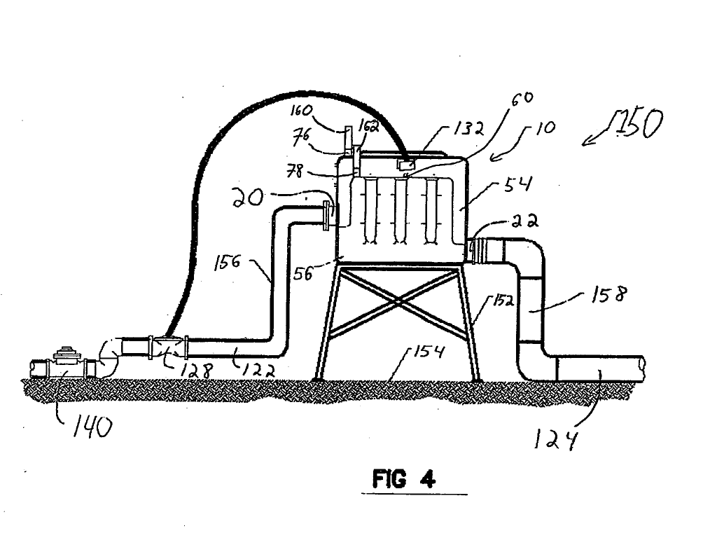

FIGS. 1 to 2C illustrate example filtration tanks in accordance with different aspects of the present invention, and FIGS. 3 and 4 illustrate examples of a filtration system in accordance with still further aspects of the invention, in which systems the filtration tank shown in FIGS. 1 and 2A is used. The filtration tanks and the filtration systems are designed for use in a drip irrigation system normally including a dripper line manifold and irrigation lines which may include drip emitters. Such drip emitters normally have a minimal pressure at which they are operable.

With reference to FIGS. 1 and 2A, a filtration tank 10 comprises a substantially cylindrical housing 12 with a central vertical axis X, having a top surface 14 comprising a sealable hatch 15, a bottom surface 16 and a side surface 18, all defining therebetween an interior of the tank 10. The side surface 18 of the housing 12 is formed with a first inlet 20 through which fluid to be filtered (not shown) enters the tank 10, and an outlet 22 at a diametrically opposite side of the tank 10, the outlet 22 being located closer to the bottom surface 16 of the housing 12 than the first inlet 20. As shown in FIG. 1, the first inlet 20 is oriented tangentially to the side surface 18 of the housing 12.

The tank 10 further comprises a partition wall 24 including a central circular portion 26, a peripheral annular portion 28 and a peripheral cylindrical portion 30 having an upper end 32 merging with the central portion 26 and a lower end 34 merging with the annular portion 28. The partition wall 24 may be in the form of one piece formed integrally with the housing 12, or only a part thereof may be formed integrally with the housing 12, whilst the remainder may be detachably attachable thereto. For example, the central circular portion 26 may be in the form of a plate detachably attachable to the peripheral cylindrical portion 30.

The peripheral annular portion 28 has an upper surface 36 facing the top of the housing 14 and a lower surface 38 facing the bottom of the housing 16. The annular portion 28 merges with the side surface of the housing 18 so that the upper surface 36 thereof is disposed below the first inlet 20, and the lower surface 38 thereof is disposed above the outlet 22. The annular portion 28 further comprises a depression 40 including a lowermost end 42 disposed lower than the first inlet 20, a first side wall 44 and a second side wall 46. The depression 40 in the peripheral annular portion 28 merges with the peripheral cylindrical portion 30 and the side surface 18 to define therebetween an interior of an impurity accumulation chamber 48.

The annular portion 28 divides the side surface 18 of the housing 12 into an upper portion 50 including the first inlet 20, and a lower portion 52 including the outlet 22. Consequently, the partition wall 24 divides the housing 12 into a first chamber 54 and a second chamber 56, which are coaxial and are disposed so that the first chamber 54 surrounds the portion of the second chamber 56 disposed within the upper portion 50 of the side surface 18 of the housing 12.

The first chamber 54 is thus defined between the partition wall 24, the top surface 14 of the housing 12 and the upper portion 50 of the side surface 18 of the housing 12 including the first inlet 20, the upper surface 36 of the annular portion 28 constituting the bottom of the first chamber 54. With the annular portion 28 comprising a depression 40 as explained above, the lowermost end 42 constituting the lowermost region of the first chamber 54. The first chamber 54 is in this case provided with a cleaning hatch 58 formed in the vicinity of the impurity accumulation chamber 48 so as to facilitate removal of impurities accumulated in the lowermost region of the annular portion 28.

It should be mentioned that the first inlet 20 does not necessarily have to be located at a diametrically opposite side of the tank 10 from the outlet 22 or in close proximity to the annular portion 28, as shown in FIG. 2A, but may be spaced therefrom (not shown) and may be located in any part of the upper portion 50 of the side surface 18 of the housing 12 and may extend to any space between the annular portion 28 and the central portion 26 of the partition wall 24, being preferably closer to the former than to the latter.

The second chamber 56 is defined between the partition wall 24, i.e. the central portion 26 and the annular portion 28 constituting the top surface of the second chamber 56, the bottom surface 16 of the housing 12, and the lower portion 52 of the side surface 18 of the housing 12 including the outlet 20. It should be mentioned that the outlet 22 does not necessarily have to be located in the immediate vicinity of the depression 40 of the annular portion 28, as shown in FIG. 2A, but may be spaced therefrom (not shown), e.g. towards the bottom surface 16 of the housing 12, i.e. the bottom of the second chamber 56.

The second chamber 56 has a second inlet generally designated as 60 formed in the central circular portion 26 of the partition wall 24, which is associated with a filter arrangement generally designated as 62. The second inlet 60 is in the form of a plurality of apertures 64, and the filter arrangement 62 is in the form of a plurality of filter elements 66. Each aperture 64 being associated with a corresponding filter element 66.

Each filter element 66 in this case is in the form of an elongated pocket 68 made of flexible material, e.g. made from an inert polymer yarn, capable of collecting impurities expected in the fluid to be filtered, and passing therethrough filtered fluid. Furthermore, algaecide chemicals can be incorporated into the yarn to further increase the time to blockage of the pocket 68.

The pocket 68 has an open end 70 fixed to the central circular portion 26 around the corresponding aperture 64 so as to be stationary with respect to fluid flow (not shown), and a tubular body 72 with a closed end 74, hanging downwardly from the open end 70 into the second chamber 56 so that a portion of the pocket 68 spaced from the open end 70 is capable of free movement relative to the open end 70. One example of dimensions of the pocket 68 is about 7 inches in diameter with a 30 inch axial length and with the distance from the second inlet 60 to the outlet 22 being about 42 inches.

The first chamber 54 has a first exhaust outlet 76 and the second chamber 56 has a second exhaust outlet 78, formed in the top surfaces thereof, constituted respectively by the top surface 14 of the housing 12 and the central circular portion 26 of the partition wall 24.

In operation fluid to be filtered (not shown), following a path (illustrated by arrows), enters the tank 10 and, particularly, the first chamber 54 via the first inlet 20, and follows a substantially helical path induced by a combination of the tangential orientation of the first inlet 20, cylindrical shape of the first chamber 54 and the vertical height difference between the first inlet 20 and the second inlet 60. The fluid traversing the helical path is subjected to centrifugal forces causing the fluid to adversely impact the first chamber's 54 periphery resulting in its precipitation along the axis X. The disposition of the second inlet 60 higher than the first inlet 20 may be selected so as to increase the length of the helical path thereby allowing impurities (not shown) that have been separated from the fluid in said precipitation to sink to the upper surface of the peripheral annular portion 36. Such precipitated impurities (not shown) located on the upper surface of the annular portion 36 may continue to move along said upper surface 36, due to forces applied to them by the motion of the fluid in which they are disposed, and subsequently descend into the impurity accumulation chamber 48.

The accumulation chamber 48 may be cleaned, preferably at a time when there is no fluid in the tank, by opening of the cleaning hatch 58 and removal of impurities found in the accumulation chamber 48.

The helical fluid path in the first chamber 54 ends when the fluid reaches the height of the second inlet 60 of the second chamber 56, in particular the apertures 64 of the second inlet 60, via which it enters the open end 70 of each pocket 68 in a swirling flow (not shown). The fluid passing through each pocket 68 consequently enters the second chamber 56 as filtered fluid (not shown) and leaves impurities (not shown) lodged in the periphery of the pocket 68. Due to the pocket 68 being capable of free movement relative to the open end 70 thereof, the lodged impurities are shaken free by free undulations caused by the swirling flow of the fluid entering the apertures 64 and by changes in the direction of surrounding fluid flow. The freed impurities subsequently sink, due to gravitational forces, and are collected in the closed end 74 of the pocket 68. The filtered fluid exits the second chamber 56 and the tank 10 via the outlet 22. The impurities remain in the closed end 74 until they are manually cleaned, for example, via removal of the sealable hatch 15, preferably at a time when there is no fluid in the tank, to gain access to the pockets 68.

The disposition of the second inlet 60 of the second chamber 56 higher than the first inlet 20 of the first chamber 54, ensures a designated minimum fluid pressure is achieved before the fluid from the first inlet 20 can access the second inlet 60 and thus second chamber 56. If the minimum pressure is not provided by the system to the fluid then it will not access the second chamber 56 and subsequently the outlet 22.

The disposition of the second inlet 60 of the second chamber 56 higher than the outlet 22 ensures a minimum required fluid pressure of fluid exiting through the outlet 22, in order to prevent fluid reaching drip emitters (not shown) at undesirable low pressure levels.

The exhaust outlets 76 and 78 may be connected to a pressure control system, as will be described in more detail below with reference to FIG. 3, or may be used for fluid to be able to exit from the respective first and second chamber if pressure therein exceeds maximal operative pressure. Furthermore, the exhaust outlets 76 and 78 may be useful in releasing air bubbles that are generally caused in hydraulic systems having fluid flow therein subjected to varying pressure levels.

FIG. 2B illustrates a filtration tank 80 whose elements common with those of the tank 10 bear the same reference numerals. The tank 80 has the same construction of its first and second chambers 54 and 56 as the tank 10, but it differs from the tank 10 in that it further comprises a collection arrangement for receiving impurities (not shown) from the pockets 68 via tubular pipes 82 connected to the closed ends 74 of the pockets 68. The tubular pipes 82 are elongated and flexible so as, on the one hand, not to restrict the free undulation of the pockets 68 and, on the other hand, to be capable themselves of free undulation, to facilitate the movement of impurities therealong. The collection arrangement is in the form of a collection chamber 84 integral with the tank 80, which comprises therein a disposal pipe 86 adapted to receive impurities from the pockets 68 and deliver them to the exterior of the tank 80.

The collection chamber 84 is separated from the second chamber 56 by a separation wall 88 formed with apertures 90 via which the pipes 82 pass into the collection chamber 84. The collection chamber 84 is further formed with a disposal outlet 92, and the disposal pipe 86 protrudes from the filtration tank 80 through the disposal outlet 92. Additionally, the disposal pipe 86 may have a valve 94 mounted thereon, whose operation may be controlled automatically or manually. A bottom hatch 96 may be provided in the collection chamber 84 to facilitate cleaning and internal maintenance of the filtration tank 80.

In operation the filtration tank 80 filters the fluid in the same manner as described for the filtration tank 10. However the impurities (not shown) in the closed end 74 of the pocket 68 will descend through the tubular pipes 82 into the disposal pipe 86 where they may be flushed by opening of the valve 94. The fluid pressure from the second chamber 56 may facilitate the flushing action. After a predetermined time the valve 94 may be closed, stopping the fluid flow through the disposal pipe 86. The flushing operation may be automated at set time periods.

FIG. 2C illustrates a filtration tank 100 whose elements common with those of the tanks 10 and 80 bear the same reference numerals. The tank 100 differs from the previously described filtration tanks 10 and 80 in that, instead of the filter pockets 68, filter sleeves 102 are used, and in that the collection chamber 84 has no tubular pipes 82 within it but rather it has disposal openings 104 in the separation wall 88 and a disposal pipe 106 with the valve 94, attached to the disposal outlet 92. Each sleeve 102 has an open top end 108 and open bottom end 110 and extends along the entire height of the second chamber 56 from an aperture 64 in the central portion 26 of the partition wall 24, which is surrounded by the top end 108 of the sleeve 102, to a disposal opening 104 in the wall which is surrounded by the bottom end 110 of the sleeve 102. The sleeve 102 may be made of the same material as the pocket 68 and may be mounted in the second chamber 56 so that a portion of the sleeve 102 spaced from the top end 108 and spaced from the bottom end 110 is capable of freely undulating by forces exerted by the fluid flow.

In operation fluid (not shown) accesses the second chamber 56 via the apertures 64 and the top end 108 of the sleeves 102. The fluid passes through the periphery of the sleeve 102 entering the second chamber 56 as filtered fluid (not shown), leaving impurities (not shown) lodged on the periphery of the sleeve 102. The lodged impurities in the sleeve 102 may be shaken free by the free undulations caused to the sleeve 102 by changes in the direction of surrounding fluid flow. The freed impurities subsequently sink, due to gravitational forces, and are collected in the collection chamber 84. The filtered fluid exits the second chamber 56 via the outlet 22. The collection chamber 84 may be periodically flushed of its contents by the opening of the valve 94. The fluid pressure from the second chamber 56 being able to cause the flushing action. After a predetermined time the valve 94 may be closed, stopping the fluid flow through the disposal pipe 106.

FIG. 3 illustrates a column control filtration system 120, included in which is the tank 10 described above, an inlet pipe 122 in fluid connection with the first inlet 20 of the tank 10, and an outlet pipe 124 in fluid communicated with the outlet 22 of the tank 10. It should be indicated that any tank similar to the tank 10, or tanks 60 and 80 described above may be used in the control system 120.

The filtration system 120 includes a column control mechanism 126 for the control of maximal pressure in the tank. The control mechanism 126 comprises a valve 128 mounted on the inlet pipe 122 for control of fluid flow from a pipe system (not shown); a fixed head pressure column 130 disposed between the valve 128 and the first inlet 20, mounted on and in fluid communication with the inlet pipe 122; a pressure control sensor 132 in the pressure column 130, capable of activating the valve 128; and first and second exhaust pipes 134 and 136. The pressure column 130 has a top portion 138 open to the atmosphere, and the pressure control sensor 132 is in the form of a float sensor adapted to sense fluid height changes in the column 130.

The first exhaust pipe 134 and the second exhaust pipe 136, each have one end connected to the respective exhaust outlets 76 and 78 of the tank 10, and whose other ends are in fluid communication with the top portion 138 of the pressure column 130.

The inlet pipe 122 comprises an irrigation meter 140 for detecting fluid pressure changes in the pipe 122 to which it is connected. This may be useful to alert farmers in cases where the fluid pressure in the inlet pipe 122 falls below a desired level. The alert may be displayed locally or may be transmitted to a computer (not shown). Alternatively, the irrigation meter 140 may be disposed on the outlet pipe 124.

Fluid pressure in the filtration system 120 is regulated as follows: if the fluid pressure in the first chamber 54 is higher than the fluid pressure in the first exhaust pipe 134 at the top portion 138, fluid (not shown) will flow through the first exhaust pipe 134 into the column 130, thus increasing the height of the fluid in the column 130, thereby activating the sensor 132 which will at least partially close the valve 128, restricting the fluid flow into the first chamber 54 and thereby lowering the fluid pressure in the tank 10. It can also be noted that the fluid from the tank 10 that flows into the column 130 may not be wasted but rather may re-enter the tank 10 via the inlet pipe 122 during the period that the valve 128 restricts flow therethrough. As the fluid pressure in the tank 10 decreases the fluid flow from the tank 10 into the column 130 via the exhaust pipe 134 eventually ceases allowing the fluid in the column 130 to drain to the tank 10 via the inlet pipe 122 decreasing the height of the fluid to the previous/desired level. Once the height of the fluid has decreased to the previous level the float sensor 132 may activate the valve 128 causing it to reopen to the setting it was at previously. Similarly if the pressure in the second chamber 56 is higher than the fluid pressure in the second exhaust pipe 136 at the top portion 138, fluid will flow through the second exhaust pipe 136 into the column 130, changing the height of the fluid in the column 130, and in a manner similar to that described above, resulting in the lowering of fluid pressure in the tank 10.

In the event of an unintentional stoppage of fluid flow in the pipe system preceding the column 130 such that fluid in the system is caused to be sucked back in a reverse flow direction, the column 130 functions to prevent dirt entering the pipe system via the tank 10. The reverse flow produces a suction effect on the inlet pipe 122 which is in fluid communication with the first inlet 20 of the tank 10 and the column 130. The fluid and air contained in the column 130 are sucked into the inlet pipe 122 and subsequently the pipe system. While the reverse flow remains the air in the column 130 continues to flow rapidly into the pipe system via the open top portion 138, eliminating the suction effect on the first inlet 20 of the tank 10.

FIG. 4 illustrates a platform control filtration system 150, in which elements common with those in the column controlled filtration system 120, bear the same reference numerals.

In the system of FIG. 4, the tank 10 is mounted on a platform 152 which is a selected vertical distance above the ground level 154. The inlet pipe 122 has an first extended vertical section 156 enabling it to reach the now elevated height of the first inlet 20. Similarly, the outlet pipe 124 has a second extended vertical section 158 enabling it to reach the ground level 154 from the now elevated height of the outlet 22.

In this embodiment the pressure control sensor 132 is a float sensor disposed in the first chamber 54, and it is adapted to control the valve 128. The tank 10 has a first short exhaust pipe 160, extending vertically from the first exhaust outlet 76 of the first chamber 54, and a second short exhaust pipe 162, extending vertically from the second exhaust outlet 78 of the second chamber 56. Unlike the exhaust pipes in FIG. 3, these exhaust pipes are short and rigid and are primarily intended for venting air pockets created by fluid pressure fluctuations in the tank.

In operation, the fluid (not shown) supplied to the inlet pipe 122 will flow through an irrigation meter 140 and the valve 128, traversing a first vertical section 156 of the inlet pipe 122 where it subsequently enters the tank 10 via the first inlet 20 and exits the tank 10 via the outlet 22.

If the fluid pressure in the inlet pipe 122 is insufficient to cause the fluid to traverse the first vertical section 156 and reach the height of the second inlet 60, fluid will not enter the second chamber 56 and hence the outlet 22. Therefore a certain minimum required fluid pressure, dependent on the height of the platform 152 and the distance from the first inlet 20 to the second inlet 60, that can cause the fluid to reach the second inlet 60 of the second chamber 56 of the tank 10, is needed for the system to operate.

If the fluid pressure in the first chamber 54 is so high as to increase the height of the fluid level in the first chamber 54 to exceed a predetermined level, then the sensor 132 will at least partially close the valve 128, restricting the fluid flow into the first chamber 54 and thereby lowering the fluid pressure in the tank 10. As the fluid pressure in the tank 10 decreases and the fluid in the first chamber 54 returns to the desired level the float sensor 132 activates the valve 128 causing it to reopen to its previous setting.

Those skilled in the art to which this invention pertains will readily appreciate that numerous changes, variations and modifications can be made without departing from the scope of the invention mutatis mutandis.

1. A filtration tank with a central vertical axis, comprising: a first chamber, a second chamber and at least one filter element; the first chamber having a first inlet through which fluid to be filtered enters the tank and being designed so as to provide a swirling flow of said fluid to the second chamber; the second chamber having a second inlet, in fluid communication with the first chamber, and an outlet through which filtered fluid exits the tank, the outlet being disposed lower than the second inlet; the filter element being disposed in the second chamber and having a portion capable of free undulation due to movement of the fluid in which it is disposed caused at least in part by said swirling.

2. A filtration tank according to claim 1, wherein said second inlet is in the form of a plurality of apertures.

3. A filtration tank according to claim 2, including a plurality of filter elements, each associated with one of said apertures.

4. A filtration tank according to claim 1, wherein said filter element has an elongated form and has an upper end which is stationary with respect to the fluid flow, a lower end and a body portion therebetween, at least part of said body portion being capable of said undulation.

5. A filtration tank according to claim 4, wherein said lower end of the filter element constitutes a part of said portion capable of the undulation.

6. A filtration tank according to claim 4, wherein said lower end is essentially fixed and said body portion is capable of said undulation at least at an area thereof spaced from the upper and lower ends of the filter elements.

7. A filtration tank according to claim 4, further comprising: a collection chamber in fluid communication with the lower end of the filter element, to receive impurities therefrom, and a disposal outlet through which impurities can exit the collection chamber.

8. A filtration tank according to claim 1, wherein said filter element's axial length approaches a vertical distance between the second inlet and the outlet.

9. A filtration tank according to claim 1, wherein said filter element is made of a flexible material.

10. A filtration tank according to claim 9, wherein said material is an inert polymer yarn.

11. A filtration tank according to claim 1, wherein said first chamber further comprises a bottom whose lowermost portion is disposed lower than the first inlet for accumulation of impurities.

12. A filtration tank according to claim 1, wherein said second inlet is disposed higher than the first inlet.

13. A filtration tank according to claim 1, wherein at least said first inlet is designed so as to induce centrifugal forces on fluid with respect to the central vertical axis, in at least a portion of a fluid flow path within the tank preceding said second inlet.

14. A filtration tank according to claim 13, wherein said first inlet is oriented tangentially to the periphery of the first chamber.

15. A filtration tank according to claim 13, wherein said first chamber and/or second chamber is substantially cylindrical, the first chamber surrounding the second chamber, the second inlet being disposed axially higher than the first inlet.

16. A filtration tank with a central vertical axis comprising: a first chamber, a second chamber and a filter element; the first chamber having a first inlet through which fluid to be filtered enters the tank; the second chamber having a second inlet in fluid communication with the first chamber, and an outlet through which filtered fluid exits the tank; the filter element being disposed in the second chamber, at least said first inlet or said first chamber being designed so as to induce centrifugal forces on fluid with respect to the central vertical axis, in at least a portion of a fluid flow path within the tank preceding said second inlet.

17. A filtration tank according to claim 16, wherein said first inlet is oriented tangentially to the periphery of the first chamber.

18. A filtration tank according to claim 16, wherein said first chamber and/or second chamber is substantially cylindrical, the first chamber surrounding the second chamber, the second inlet being disposed axially higher than the first inlet.

19. A filtration system comprising a filtration tank according to claim 1, comprising a control mechanism capable of varying the rate of a fluid flow into said first inlet such that a regulated pressure range can be maintained for the fluid flow across the filtration system; wherein said control mechanism comprises:
an inlet pipe in fluid communication with said first inlet;
a valve mounted on the inlet pipe;
an outlet pipe in fluid communication with said outlet; and
a pressure control sensor capable of detecting fluid pressure changes and activating the valve.

20. The filtration system of claim 19, said control mechanism further comprising:
a fixed head pressure column, having a top portion open to the atmosphere, mounted on and in fluid communication with said inlet pipe, disposed between said valve and said first inlet, said pressure control sensor disposed therein;
a first exhaust outlet integrally formed in the top portion of the first chamber;
a second exhaust outlet integrally formed in the top portion of the second chamber;
a first exhaust pipe fitted to the first exhaust outlet;
a second exhaust pipe fitted to the second exhaust outlet; and
wherein said pressure control sensor is a float sensor and said first exhaust pipe and said second exhaust pipe are secured to said column above the height of the first exhaust outlet and the second exhaust outlet.

21. The filtration system according to claim 19, wherein:
said tank is disposed at an elevated position relative to the ground and said pressure control sensor is a float sensor displaced in said first chamber.

22. The filtration system according to claim 19, having a design so as to induce centrifugal forces on at least a portion of said fluid flow within the tank with respect to the central vertical axis.

23. A filtration system comprising a filtration tank according to claim 16, further comprising a control mechanism capable of varying the rate of a fluid flow into said first inlet such that a regulated pressure range can be maintained for the fluid flow across the filtration system; wherein said control mechanism comprises:
an inlet pipe in fluid communication with said first inlet;
a valve mounted on the inlet pipe;
an outlet pipe in fluid communication with said outlet;
a pressure control sensor capable of detecting fluid pressure changes and activating the valve.

24. The filtration system of claim 23, said control mechanism further comprising:
a fixed head pressure column, having a top portion open to the atmosphere, mounted on and in fluid communication with said inlet pipe, disposed between said valve and said first inlet, said pressure control sensor disposed therein;
a first exhaust outlet integrally formed in the top portion of the first chamber;
a second exhaust outlet integrally formed in the top portion of the second chamber;
a first exhaust pipe fitted to the first exhaust outlet;
a second exhaust pipe fitted to the second exhaust outlet; and
wherein said pressure control sensor is a float sensor and said first exhaust pipe and said second exhaust pipe are secured to said column above the height of the first exhaust outlet and the second exhaust outlet.

25. The filtration system according to claim 23, wherein:
said tank is disposed at an elevated position relative to the ground and said pressure control sensor is a float sensor displaced in said first chamber.

26. The filtration system according to claim 23, wherein said filter element, disposed in the second chamber, has a portion of which being capable of free undulation due to movement of the fluid in which it is disposed.

27. A filtration system for use with an irrigation system comprising a filtration tank, a fixed head pressure column and a pipe system for providing fluid to the tank and column; the tank having a central vertical axis and comprising: a first chamber, a second chamber and at least one filter element; the first chamber having a first inlet in fluid communication with said pipe system through which fluid to be filtered enters the tank; the second chamber having a second inlet in fluid communication with the first chamber, and an outlet through which filtered fluid exits the tank, the outlet being disposed lower than the second inlet; the fixed head pressure column having a top portion open to the atmosphere, and being mounted on and in fluid communication with said pipe system, for eliminating the suction of dirt into the pipe system.
